(19) United States
(12) Patent Application Publication
(10) Pub. No.: US 2004/0025421 A1
(43) Pub. Date: Feb. 12, 2004

(54) Multilayer plastic sheeting for mulching and/or as a barrier for soil treating agents

(76) Inventors: Bartolomeo Forzano, Mondovi (IT); Gianfranco Ferrero, Mondovi (IT)

Correspondence Address: James C Wray, 1493 Chain bridge road, Suite 300, McLean, VA, 22101, US

(21) Appl. No.: 10/381,877

(22) PCT Filed: Nov. 29, 2000
(86) PCT No.: PCT/EP00/11919

(30) Foreign Application Priority Data
Dec. 13, 1999 (IT) SV99A000040

(51) Int. Cl. A01G 7/00

(52) U.S. Cl. 47/9

(57) ABSTRACT

The invention relates to a multilayer plastic sheeting designed for mulching and/or as a barrier for retaining treating agents, particularly soil sterilants, and for preventing said treating agents from being diffused in the atmosphere. In accordance with the invention, the covering sheet comprises a layer of polyamide or of mixtures of pure polyamides or of mixtures of a polyamide and one or more different polymers or of mixtures of several polyamides and one or more different polymers. Multilayer structures may be also provided in which at least one of the two outermost layers consists of at least one sheet, film, or the like of polyamide, or of mixtures of pure polyamides, or of mixtures of a polyamide and one or more different polymers or of mixtures of several polyamides and one or more different polymers. A sheeting in accordance with the invention also ensures an excellent impermeability to sterilants, particularly to gases or vapors thereof, as well as a high mechanical strength, particularly tensile or pull-out strength.

The present invention relates to a plastic sheeting designed for mulching and/or as a barrier for retaining treating agents particularly soil sterilants, and for preventing said treating agents from being diffused in the atmosphere.

In prior art, soils that are to be sterilized by spraying gaseous or liquid sterilants thereon or by any other treating effect, are known to be covered with plastic sheetings. This spraying operation may be effected with hot gas, cold gas or with the so-called “drip irrigation”, i.e. by spreading liquid treating agents, with or without water.

First, sheetings are stretched on the soil to be treated and then, treating agents are released thereunder by means of appropriate spraying systems. The action of homogeneously stretching the sheetings on the soil involves the exertion of a relatively high mechanical tensioning force on the sheetings, which may rather frequently cause ruptures in the sheetings, especially when they are laid down, but even after a certain period of use. To date, this drawback is one of the greatest obstacles to the extensive use of this sterilization technique in combination with gastight films.

Nevertheless there is a strong need of sheetings with good performances, because environment protection and personal safety regulations increasingly restrict the free use of treating agents.

Using treating agents, particularly gases, in combination with retention sheetings firstly allows to reduce treating agent spreading losses, thereby limiting consumption and/or doses with consequent advantages in terms of costs and impact on the environment, as well as on the personnel employed on treatments and cultivation.

Moreover, while keeping a reduced dose, retention allows to maintain an atmosphere of these treating agents for a longer time, thereby providing a synergic effect.

Therefore, an effective use of barriers would allow to reduce diffusion of these agents in the atmosphere, while providing the possibility to treat larger surfaces and/or to reduce the concentration of treating agents.

Hence, the invention aims at obviating the above drawbacks and to this end, it provides, in its simplest version, a sheeting which consists of a single layer of polyamide, or of mixtures of pure polyamides or of mixtures of a polyamide and one or more different polymers or of mixtures of several polyamides and one or more different polymers.

An embodiment may be also provided in which the sheeting has a multi-layer structure wherein at least one of the two outermost layers consists of a film, a sheet, or the like of polyamide, or of mixtures of pure polyamides, or of mixtures of a polyamide and one or more different polymers or of mixtures of several polyamides and one or more different polymers, whereas one or more inner layers are made of any plastic material, such as PE or else.

In a preferred embodiment, both outer layers of the multi-layer structure consist of polyamide or of mixtures of pure polyamides or of mixtures of a polyamide and one or more different polymers or of mixtures of several polyamides and one or more different polymers.

An additional improvement consists in forming at least one of the outer layers with a plurality of films or sheets of polyamide or of mixtures of pure polyamides, or of mixtures of a polyamide with one or more different polyamides or of mixtures of several polyamides and one or more polymers which may be attached to each other directly or with the interposition of one or more intermediate adhesive layers, the outermost layer being always made of polyamide or of mixtures of pure polyamides or of mixtures of a polyamide and one or more different polymers or of mixtures of several polyamides and one or more different polymers.

The film may be manufactured with several different techniques, particularly:

by extrusion or coextrusion when it is a multilayer film, with a flat die or bubble technology;

by the so-called “extrusion coating”;

by adhesion.

Alternatively thereto or in combination therewith the outer layers on the two faces may also have intermediate layers made of different materials.

The intermediate layer may also in turn have a multi-layer structure which may or may not comprise itself polyamide layers. Nevertheless, preferably these layers are on the outside, whereas the individual inner layers are made of identical, similar or different materials.

In all the above cases, the individual films or layers may be attached directly or with the interposition of layers made of a material being compatible in terms of adhesive properties with the two layers to be attached when the latter are incompatible with each other.

In any case, in all provided combinations, regardless of their complexity, at least one of the outermost layers is always made of polyamide.

In the preferred multi-layer version, the sheeting includes an intermediate layer made of a plastic material, such as polyethylene, appropriately modified to be adhered to the layers of polyamide or the like, having on each of its faces a superposed outer layer of polyamide or of a plastic material containing polyamides, attached either directly or with the interposition of intermediate layers made of a material which is compatible with polyamide-based layers and with the intermediate polyethylene layers.

No particular restriction is provided for layer thickness. However, typically sheetings may have thicknesses of the order of 10 to 100 micron, with polyamide or polyamide-based plastic layers as thick as a few micron to a few tenths of micron.

Unlike prior art arrangements, in which barrier layers are disposed in the interior of the multi-layer structure of sheetings, this invention provides barrier layers on the exterior side of the multi-layer structure.

Surprisingly, this construction provides, with an equal barrier action, an unexpected mechanical resistance, particularly to tear, cut and puncture, which is considerably increased as compared with the results obtainable to date, while keeping the same number of layers and of materials in use, as well as the same thicknesses.

In combination with polyamides, such as nylon, other polymers may be used, such as ethylvinyl alcohol (EVOH), polyvinyl alcohol (FVOH), polyvinylidene chloride (PVDC) polymers, or others.

The barrier layer of the sheeting according to the invention may be made of a single polymer (monopolymeric layer) or of a copolymer or even of a mixture of polymers, particularly of a mixture of at least one polyamide and one or more polymers.

The invention also addresses a method of soil treatment, particularly of soil sterilization, which includes disposing a layer which is impermeable to the gases, fumes or vapors of treating agents on the soil, which layer consists of a sheeting, having at least one polyamide or polyamide-based plastic layer and a layer of a different plastic material, such as polyethylene, which is laid and stretched on the soil; and then applying treating agents, by means of vaporization, spraying, irrigation.

Thanks to the sheeting of the invention, a barrier may be provided against diffusion of soil treating agents, particularly soil sterilants, in the atmosphere. This barrier has a considerable gas-tightness, as well as a notably increased mechanical strength as compared with traditional impermeable films. This ensures a long-lasting barrier effect and allows the use of the sheeting as a mulching sheet. In fact, the increased mechanical strength reduces sheeting damages and allows the sheeting to remain intact for its mulching function.

The extended use of the sheeting allows not only mulching, but also treatments requiring an effective retention of soil and/or plant treating gases even in the advanced stage of cultivation. The whole obviously without requiring a sheeting to be laid off again, which is not easy in the advanced stage of cultivation, due to the presence of plants.

Obviously, the invention is not limited to the embodiments described above, but also comprises designs achieving an equal utility while using the same inventive concept.

1. Plastic sheeting designed for mulching and/or as a barrier for retaining treating agents, particularly soil sterilants and for preventing said treating agents from being diffused in the atmosphere, characterized in that the covering sheet comprises a layer of polyamide or of mixtures of pure polyamides or of mixtures of a polyamide and one or more different polymers or of mixtures of several polyamides and one or more different polymers.

2. A sheeting as claimed in claim 1, characterized in that it has a multi-layer structure wherein at least one of the two opposite outermost layers of the structure consists of a sheet, a film, or the like of polyamide, or of mixtures of pure polyamides, or of mixtures of a polyamide and one or more different polymers or of mixtures of several polyamides and one or more different polymers, whereas one or more inner layers consist of any plastic material.

3. A sheeting as claimed in claim 1 or 2, characterized in that both outer layers of the multi-layer structure consist of polyamide or of mixtures of pure polyamides or of mixtures of a polyamide with one or more different polymers or of mixtures of several polyamides with one or more different polymers.

4. A sheeting as claimed in one or more of the preceding claims, characterized in that at least one or more of the inner layers are made of PE, polyethylene.

5. A sheeting as claimed in one or more of the preceding claims, characterized in that at least one of the outer layers is in turn formed by a plurality of layers of polyamide or of mixtures of pure polyamides, or of mixtures of a polyamide with one or more different polyamides or of mixtures of several polyamides with one or more polymers which may be attached and/or coextruded to each other directly or with the interposition of an intermediate compatibility layer, the outermost layer being always made of polyamide or of mixtures of pure polyamides or of mixtures of a polyamide and one or more different polymers, or of mixtures of several polyamides and one or more different polymers.

6. A sheeting as claimed in one or more of the preceding claims, characterized in that at least one of the outer layers is in turn formed by a plurality of layers of polyamide or of mixtures of pure polyamides, or of mixtures of a polyamide with one or more different polyamides or of mixtures of several polyamides with one or more polymers which may be attached and/or coextruded to each other directly or with intercalated layers of a different plastic material, the outermost layer being always made of polyamide or of mixtures of pure polyamides or of mixtures of a polyamide and one or more different polymers, or of mixtures of several polyamides and one or more different polymers.

7. A sheeting as claimed in one or more of the preceding claims, characterized in that one or more intermediate layers of identical or different plastic materials are provided and that they are intercalated in a certain order and attached and/or coextruded directly or with the interposition of compatibility layers.

8. A sheeting as claimed in one or more of the preceding claims, characterized in that in all provided combinations, regardless of their complexity, at least one of the outermost layers is always made of polyamide.

9. A sheeting as claimed in one or more of the preceding claims, characterized in that sheetings may have thicknesses of the order of 10 to 100 micron, with polyamide or polyamide-based plastic layers as thick as a few micron to a few tenths of micron.

10. A sheeting as claimed in one or more of the preceding claims, characterized in that, in combination with polyamides, other polymers may be used, such as ethylvinyl alcohol (EVOH), polyvinyl alcohol (PVOH), polyvinylidene chloride (PVDC) polymers, or others.

11. A method of soil treatment, particularly of soil sterilization, method, characterized by the following steps:
disposing on the soil a layer which is impermeable to the gases, fumes or vapors of treating agents on the soil, which layer consists of a sheeting, having at least one outer polyamide or polyamide-based plastic layer, and a layer of a different plastic material, such as polyethylene, as claimed in one or more of the preceding claims, which is laid and stretched on the soil;
applying treating agents, by means of vaporization, spraying, irrigation.

12. A multilayer plastic sheeting designed for mulching and/or as a barrier for retaining treating agents, particularly soil sterilants wholly or partly, substantially as described, illustrated and for the purposes stated herein.
